(19) United States
(12) Patent Application Publication
(10) Pub. No.: US 2013/0177430 A1
(43) Pub. Date: Jul. 11, 2013

(54) SYSTEM AND METHOD FOR REDUCING STRESS IN A ROTOR

(71) Applicants: Yatheesh Kumar Aluvala, Bangalore (IN); Kashif Akhtar, Bangalore (IN); Ganesh Pejavar Narayana Rao, Bangalore (IN)

(72) Inventors: Yatheesh Kumar Aluvala, Bangalore (IN); Kashif Akhtar, Bangalore (IN); Ganesh Pejavar Narayana Rao, Bangalore (IN)

(73) Assignee: GENERAL ELECTRIC COMPANY, Schenectady, NY (US)

(21) Appl. No.: 13/343,897

(22) Filed: Jan. 5, 2012

(51) Int. Cl. F01D 5/14; B23P 13/00

(52) U.S. Cl. 416/223 A; 29/557

(57) ABSTRACT

A system for reducing stress in a rotor includes a rotor body, a bore extending axially through the rotor body, and a plurality of impeller vanes radially disposed on the rotor body. Each impeller vane includes a first end proximate to the bore, and an undercut feature at the first end of each impeller vane removes a portion of each impeller vane proximate to the bore. The present invention may also include a method for reducing stress in a rotor that includes machining an undercut feature at a first end of a plurality of impeller vanes disposed on a rotor body.

### FIELD OF THE INVENTION

The present invention generally involves a system and method for reducing stress in a rotor. Particular embodiments of the present invention may include an undercut feature machined into the rotor to reduce thermal stresses in the rotor and/or separate mechanical and thermal stresses in the rotor to extend the fatigue life of the rotor.

### BACKGROUND OF THE INVENTION

Gas turbines are widely used in industrial and commercial operations. A typical gas turbine includes a compressor at the front, one or more combustors around the middle, and a turbine at the rear. The compressor imparts kinetic energy to the working fluid (e.g., air) to produce a compressed working fluid at a highly energized state. The compressed working fluid exits the compressor and flows to the combustors where it mixes with fuel and ignites to generate combustion gases having a high temperature and pressure. The combustion gases flow to the turbine where they expand to produce work. For example, expansion of the combustion gases in the turbine may rotate a shaft connected to a generator to produce electricity.

The compressor and the turbine typically share a common rotor which extends from near the front of the compressor, through the combustor section, to near the rear of the turbine. The rotor is generally manufactured from low alloy steel and may approach or exceed 100 tons in weight. The rotor is designed to handle substantial mechanical stress, and during transient operations of the gas turbine, the rotor may experience substantial thermal stress as well. For example, during startup of the gas turbine, the outer portion of the rotor heats up faster than the inner portion of the rotor. The temperature gradient across the rotor profile produces substantial thermal stress across the rotor that is generally proportional to Tₘₐₓ-Tₐᵥₑ, where Tₘₐₓ is the maximum temperature across the rotor profile and Tₐᵥₑ is the average temperature across the rotor profile. In the compressor section, Tₘₐₓ may approach the temperature of the compressed working fluid exiting the compressor, and in the turbine section, Tₘₐₓ may approach the temperature of the combustion gases entering the turbine. Tₐᵥₑ is initially ambient temperature during a cold startup of the gas turbine. The thermal stress across the rotor continues until the temperature across the rotor profile reaches equilibrium, which may be 12 hours or longer, and substantially reduces the low cycle fatigue limit of the rotor.

Various systems and methods are known in the art for reducing the thermal stress across the rotor. For example, the rotor may be made up of a plurality of rotor bodies or rotor wheels axially aligned and connected together, and impeller vanes between adjacent rotor wheels may direct a portion of the compressed working fluid from the compressor to flow radially inward and through the rotor. The diverted fluid decreases the thermal stress across the rotor by reducing the differential temperature between Tₘₐₓ and Tₐᵥₑ and allowing the rotor to reach equilibrium temperature in a shorter period of time.

Although effective at reducing the thermal stress across the rotor, the impeller vanes tend to heat up or cool down faster than the remainder of the rotor wheels. As a result, the impeller vanes create additional thermal stress at the joint between the impeller vanes and the rotor wheels. This additional thermal stress may coincide with the existing mechanical stress in the rotor wheels to adversely impact the fatigue life of the rotor wheels. Therefore, an improved system and method that reduces thermal stress and/or separates the thermal stress from the mechanical stress in the rotor would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for reducing stress in a rotor. The system includes a rotor body, a bore extending axially through the rotor body, and a plurality of impeller vanes radially disposed on the rotor body. Each impeller vane includes a first end proximate to the bore, and an undercut feature at the first end of each impeller vane removes a portion of each impeller vane proximate to the bore.

Another embodiment of the present invention is a system for reducing stress in a rotor that includes a rotor body, a plurality of impeller vanes radially disposed on the rotor body, a mechanical stress location on the rotor, and a thermal stress location on the rotor. An undercut feature on each impeller vane separates the mechanical stress location from the thermal stress location.

The present invention may also include a method for reducing stress in a rotor that includes machining an undercut feature at a first end of a plurality of impeller vanes disposed on a rotor body.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified side cross-section view of an exemplary gas turbine;

FIG. 2 is a perspective view of a rotor wheel according to one embodiment of the present invention;

FIG. 3 is a section profile of a portion of the rotor wheel shown in FIG. 2 according to one embodiment of the present invention;

FIG. 4 is an enlarged perspective view of the undercut features shown in FIG. 2;

FIG. 5 is a section profile of a portion of a baseline rotor wheel;

FIG. 6 is a section profile of a portion of the rotor wheel according to one embodiment of the present invention; and

FIG. 7 is a section profile of a portion of the rotor wheel according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for reducing stress in a rotor. In particular embodiments, an undercut feature in the rotor may reduce thermal stresses in the rotor and/or separate mechanical and thermal stresses in the rotor. Alternately, or in addition, a stress relieve slit in the rotor may reduce thermal stresses radially across the rotor. The undercut feature and/or slit may be readily machined into new or existing rotors to dramatically improve the fatigue life of the rotor. Although exemplary embodiments of the present invention will be described generally in the context of a rotor incorporated into a gas turbine for purposes of illustration, one of ordinary skill in the art will readily appreciate that embodiments of the present invention may be applied to any rotor and are not limited to gas turbine applications unless specifically recited in the claims.

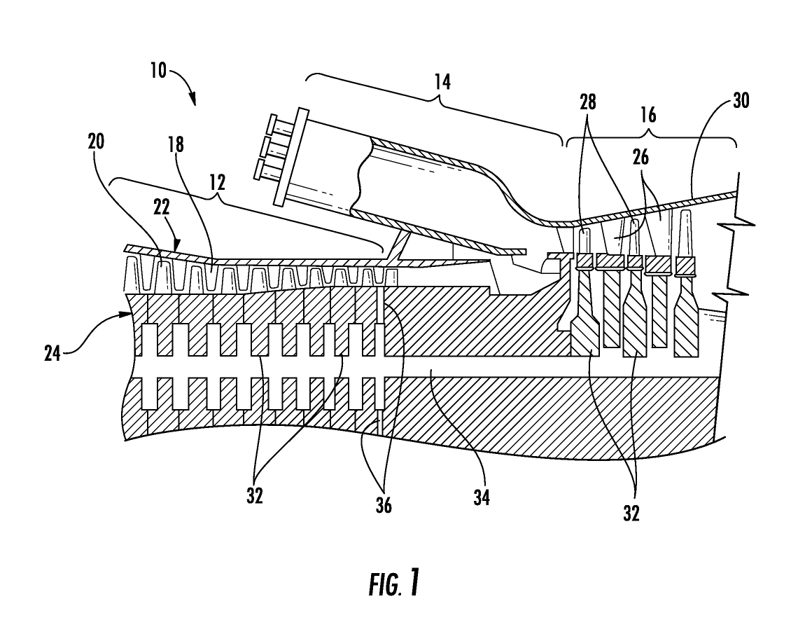

FIG. 1 provides a simplified side cross-section view of an exemplary gas turbine 10 to illustrate various embodiments of the present invention. As shown, the gas turbine 10 generally includes a compressor 12, one or more combustors 14 downstream from the compressor 12, and a turbine 16 downstream from the combustors 14. The compressor 12 generally includes alternating stages of axially aligned stator vanes 18 and rotating blades 20. The stator vanes 18 are circumferentially connected to a compressor casing 22, and the rotating blades 20 are circumferentially connected to a rotor 24. As the rotor 24 turns, the stator vanes 18 and rotating blades 20 progressively impart kinetic energy to a working fluid (e.g., air) to produce a compressed working fluid at a highly energized state. The compressed working fluid then flows to one or more combustors 14 radially arranged around the rotor 24 where it mixes with fuel and ignites to produce combustion gases having a high temperature and pressure. The combustion gases exit the combustors 14 and flow along a hot gas path through the turbine 16. The turbine 16 includes alternating stages of axially aligned stator vanes 26 and rotating buckets 28. The stator vanes 26 are circumferentially connected to a turbine casing 30, and the rotating buckets 28 are circumferentially connected to the rotor 24. Each stage of stator vanes 26 directs and accelerates the combustion gases onto the downstream stage of rotating buckets 28 to produce work.

As shown in FIG. 1, the rotor 24 may include a number of rotor bodies or wheels 32 axially aligned and connected to transmit torque between the turbine 16 and the compressor 12. Each rotor body or wheel 32 may include one or more cavities that form an axial bore 34 through the rotor 24. One or more of the adjacent rotor wheels 32 may include a fluid passage 36 that provides fluid communication between the compressor 12 and the bore 34. In this manner, a portion of the compressed working fluid from the compressor 12 may be diverted around or bypass the combustors 14 and supplied directly to the turbine 16 for various reasons. For example, the diverted fluid may be used to pressurize the rotor cavities to produce a desired differential pressure between the rotor cavities and the hot gas path in the turbine 16. Alternately, or in addition, the diverted fluid may be used to provide cooling to various components in the turbine 16.

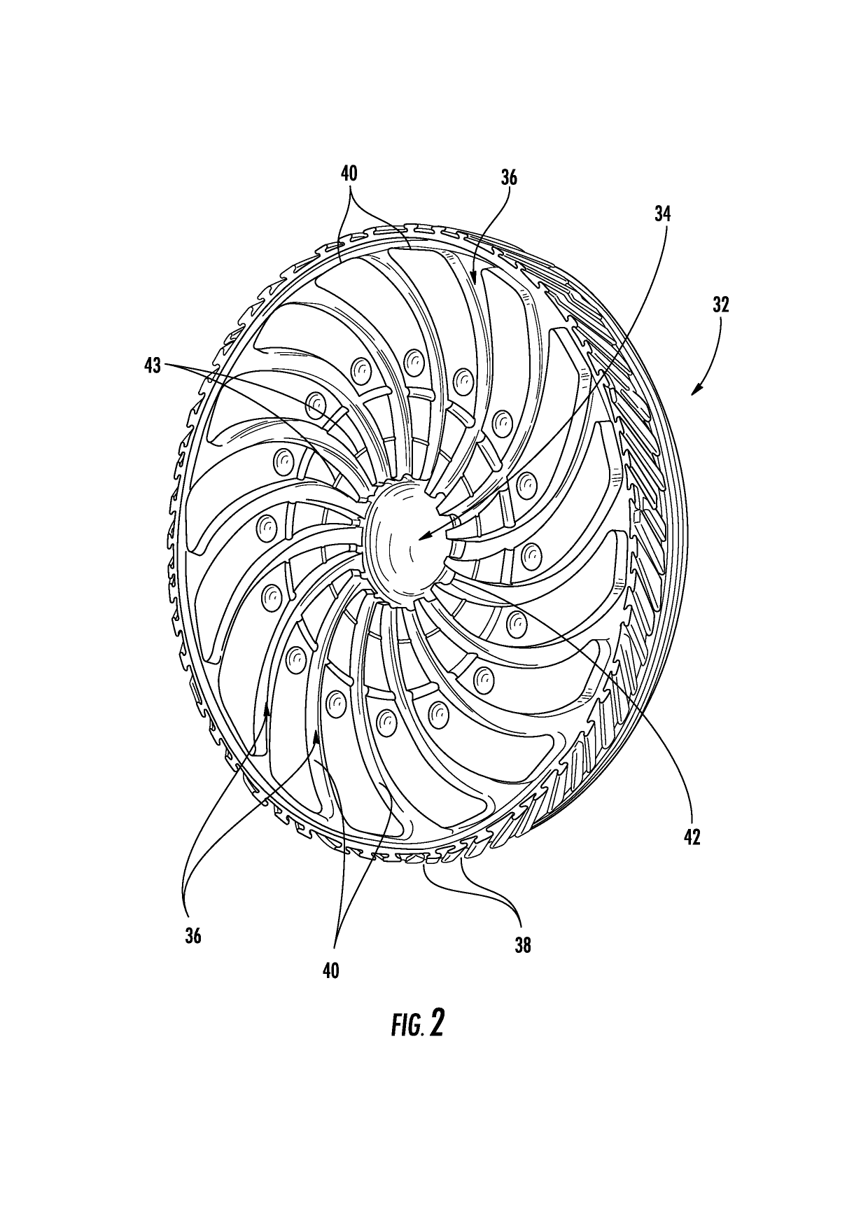

FIG. 2 provides a perspective view of the rotor wheel 32 according to one embodiment of the present invention. As shown, the outer circumference of the rotor wheel 32 may include a plurality of dovetail slots 38 configured to receive the rotating blades 20. In addition, the radial face of the rotor wheel 32 may include one or more projections or impeller vanes 40 radially disposed on the rotor wheel 32. Each impeller vane 40 may include a first end 42 proximate to the bore 34, and adjacent projections or impeller vanes 40 on the surface of the rotor wheel 32 may define the fluid passage 36 radially across the rotor wheel 32. In this manner, as the rotor wheel 32 rotates counter-clockwise as shown in FIG. 2, the impeller vanes 40 may divert a portion of the compressed working fluid through the fluid passages 36 to the bore 34. The diverted fluid decreases the thermal stress across the rotor wheel 32 by reducing the differential temperature between Tₘₐₓ and Tₐᵥₑ and allowing the rotor wheel 32 to reach equilibrium temperature in a shorter period of time.

The impeller vanes 40 shown in FIG. 2 tend to heat up or cool down faster than the remainder of the rotor wheels 32. As a result, the impeller vanes 40 create additional thermal stress along the impeller vanes 40, particularly at the intersection of the impeller vanes 40 and the rotor wheels 32. For example, during startup, the thermal stress is greatest at the first end 42 of the impeller vanes 40 where the differential temperature between Tₘₐₓ and Tₐᵥₑ is the greatest. As shown in FIG. 2, one or more impeller vanes 40 may include a stress relief slit 43 and/or an undercut feature 44 to reduce the thermal stress at the first end 42 of the impeller vane 40.

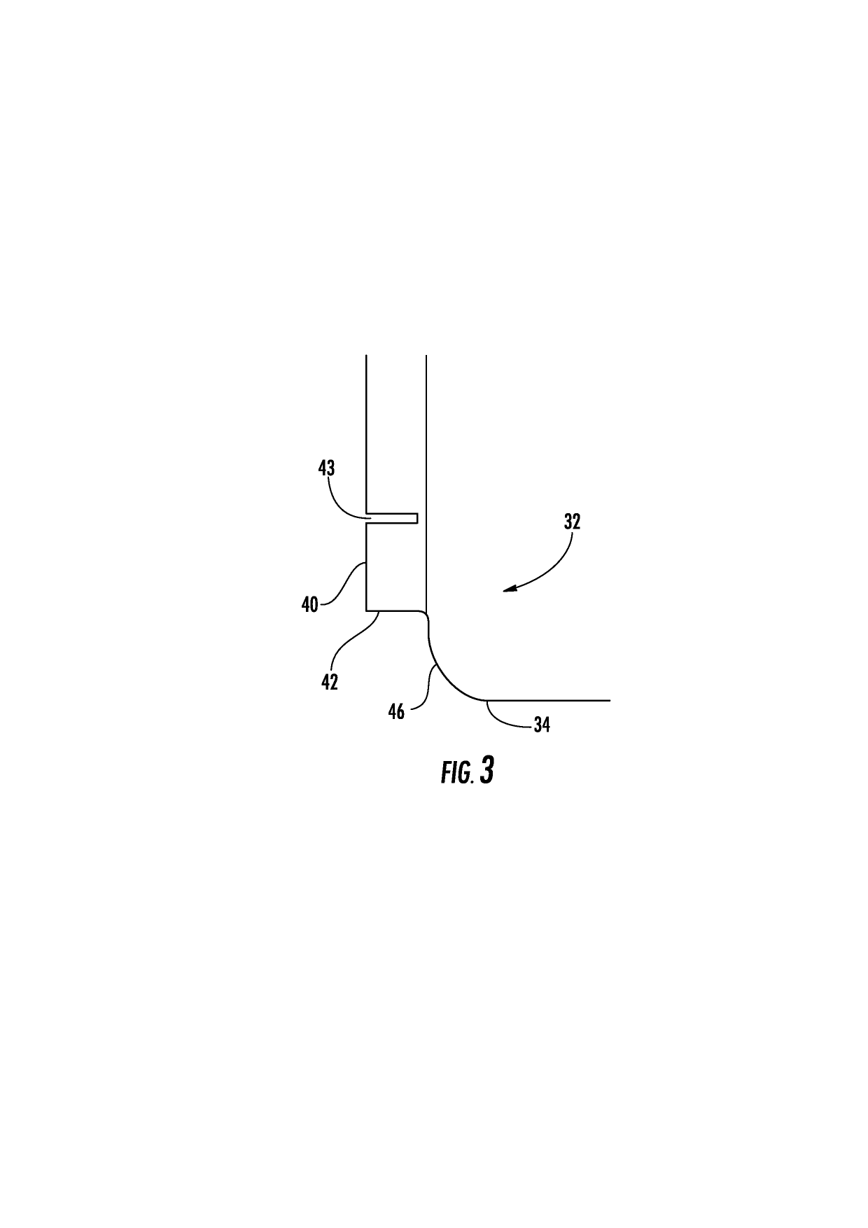

FIG. 3 provides a section profile of a portion of the rotor wheel 32 shown in FIG. 2 to illustrate the stress relief slit 43 shown in FIG. 2. As shown, the slit 43 is generally located closer to the first end 42 than the outer circumference of the impeller vane 40 and may have a width and depth sufficient to create a discontinuity in any thermal stresses that may exist across the surface of the impeller vane 40. For example, the slit 43 may have a width of approximately 0.1 inches and a depth of approximately 20-80% of the thickness of the impeller vane 40. In particular embodiments, the slit 43 may have a width between approximately 0.1 and 0.5 inches and a depth equal to the thickness of the impeller vane 40. In either event, the slit 43 may be readily machined into existing or new rotor wheels 32 to reduce the thermal stresses across the rotor wheel 32 and thereby extend the fatigue life of the rotor wheel 32.

FIG. 4 provides an enlarged perspective view of the rotor wheel 32 shown in FIG. 2 to more clearly show an undercut feature 44 located at the first end 42 of each impeller vane 40. As shown, undercut feature 44 removes a portion of each impeller vane 40 proximate to the bore 34. Undercut feature 44 generally extends across a width or dimension of each impeller vane 40 and may have a radius of greater than approximately 0.1 inches, greater than approximately 0.25 inches, between approximately 0.45 and 0.65 inches, or even larger in particular embodiments. Alternately, one or more undercut features 44 may include a compound groove in one or more impeller vanes 40, wherein a first portion of the undercut feature 44 has a first radius, and a second portion of the undercut feature 44 has a second radius. However, the particular radius or shape of the undercut feature 44 is not a limitation of the present invention unless specifically recited in the claims.

In the particular embodiment shown in FIG. 4, the rotor wheel 32 may further include a curved or arcuate surface 46 around the bore 34 proximate to and/or connected to the undercut features 44. Connecting or blending the undercut features 44 with the arcuate surface 46 around the bore reduces the stiffness of impeller vane 40 and decreases thermal stress significantly.

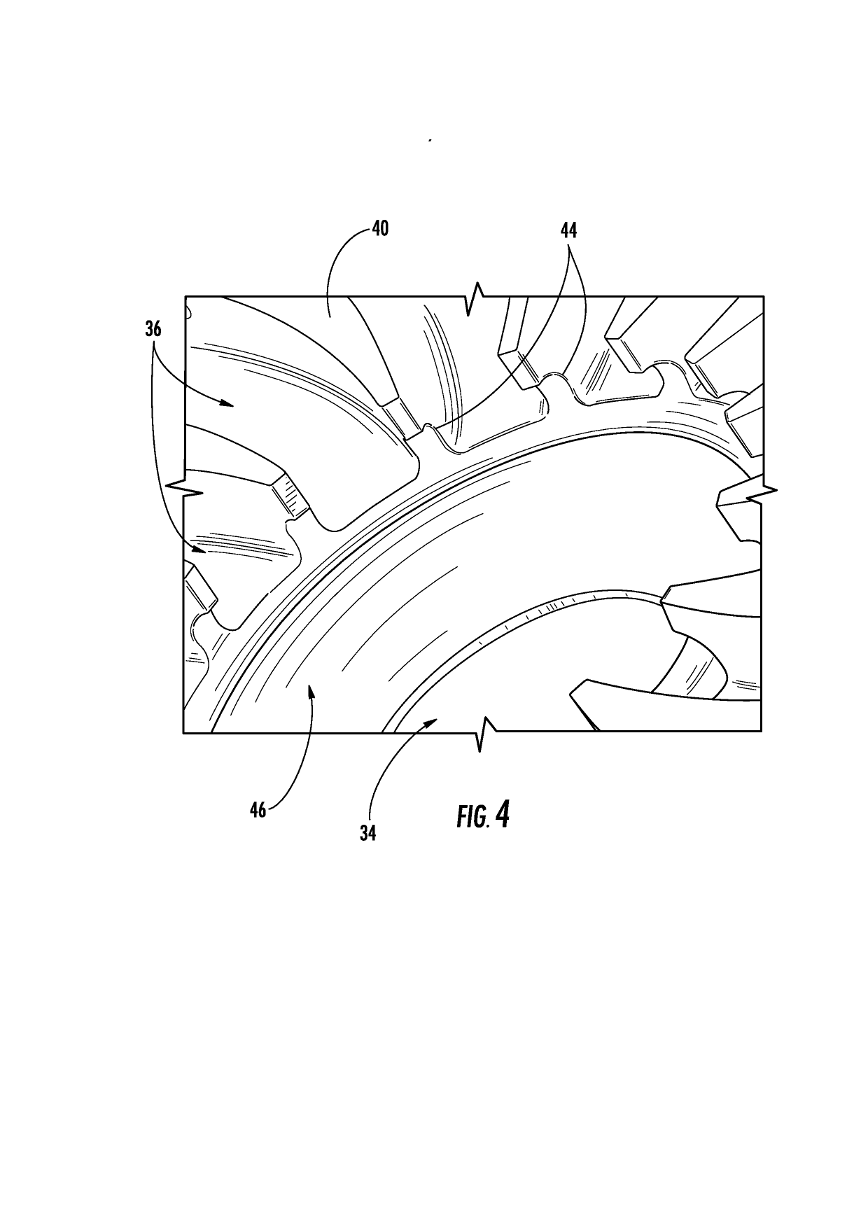

FIGS. 5-7 provide section profiles of a portion of the rotor wheel 32 to illustrate various embodiments of the present invention. Specifically, FIG. 5 shows a section profile of a baseline rotor wheel 32 without the undercut feature 44. As shown in FIG. 5, the rotor wheel 32 includes a thermal stress location 48 at the first end 42 where the impeller vane 40 intersects with the rotor wheel 32. Notably, the rotor wheel 32 also includes a mechanical stress location 50 coincidental with the thermal stress location 48. As a result, the thermal and mechanical stresses in the rotor wheel 32 combine to substantially reduce the fatigue life of the baseline rotor wheel 32 shown in FIG. 5.

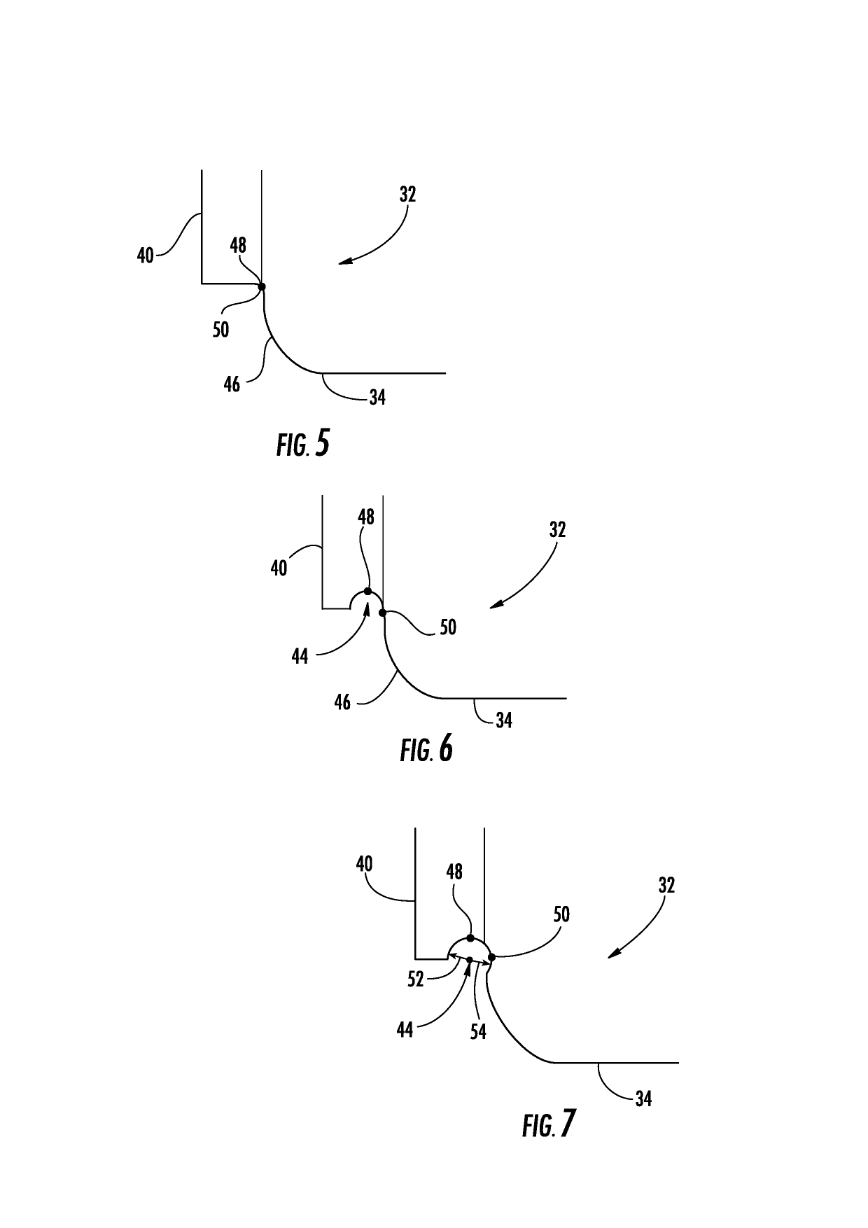

In contrast, FIG. 6 shows an embodiment in which the undercut feature 44 is located at the first end 42 of the impeller vane 40. As shown, the undercut feature 44 removes a portion of the impeller vane 40 to reduce the thermal stress at the first end 42 of the impeller vane 40. In addition, the undercut feature 44 effectively repositions the thermal stress location 48, thereby separating the thermal stress location 48 from the mechanical stress location 50. As a result, the thermal and mechanical stresses 48, 50 no longer coincide or combine with one another, and the undercut feature 44 extends the low cycle fatigue life of the rotor wheel 32.

As shown in FIG. 7, the undercut feature 44 is again located at the first end 42 of the impeller vane 40. In this particular embodiment, the undercut feature has a compound groove. Specifically, the undercut feature 44 has a first radius 52 to remove a portion of the first end 42 of the impeller vane 40 to reduce the thermal stress at the first end 42 of the impeller vane 40. In addition, the undercut feature 44 has a second radius 54 to remove a portion of the rotor wheel 32 proximate to the first end 42 of the impeller vane 40. As a result, the undercut feature 44 further separates the thermal stress location 48 from the mechanical stress location 50, further extending the fatigue life of the rotor wheel 32 compared to the embodiment shown in FIG. 6.

The various embodiments shown in FIGS. 2-4 and 6-7 provide a method for reducing stress in a rotor. The method may include machining the slit 43 and/or the undercut feature 44 near or at the first end 42 of impeller vanes 40 disposed on the rotor body or wheel 32. In doing so, the method reduces the thermal stress created by the impeller vanes 40 and/or separates the thermal stress location 48 from the mechanical stress location 50 on the rotor wheel 32. In particular embodiments, the method may further include machining at least a portion of the undercut feature 44 into the rotor body or wheel 32 proximate to the impeller vanes 40. As a result, the slits 43 and/or undercut features 44 shown in FIGS. 2-4 and 6-7 may be readily machined or cut into new or existing rotor wheels 32 to substantially extend the fatigue life of the rotor wheels 32. A longer fatigue life of the rotor wheels 32 substantially reduces outages associated with inspections and/or repairs to existing rotor wheels 32.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for reducing stress in a rotor, comprising:
a. a rotor body;
b. a bore extending axially through the rotor body;
c. a plurality of impeller vanes radially disposed on the rotor body, wherein each impeller vane includes a first end proximate to the bore; and
d. an undercut feature at the first end of each impeller vane, wherein each undercut feature removes a portion of each impeller vane proximate to the bore.

2. The system as in claim 1, wherein each undercut feature removes a portion of the rotor body proximate to the first end of each impeller vane.

3. The system as in claim 1, further comprising a slit in one or more impeller vanes proximate to the first end.

4. The system as in claim 1, wherein each undercut feature connects to an arcuate surface around the bore.

5. The system as in claim 1, wherein the impeller vanes define a fluid passage across the rotor body.

6. The system as in claim 1, wherein each undercut feature extends across a dimension of each impeller vane.

7. The system as in claim 1, further comprising a maximum mechanical stress location and a maximum thermal stress location on the rotor, and each undercut feature separates the maximum mechanical stress location from the maximum thermal stress location.

8. The system as in claim 1, wherein each undercut feature comprises a compound groove.

9. A system for reducing stress in a rotor, comprising:
a. a rotor body;
b. a plurality of impeller vanes radially disposed on the rotor body;
c. a maximum mechanical stress location on the rotor;
d. a maximum thermal stress location on the rotor; and
e. an undercut feature on each impeller vane, wherein each undercut feature separates the maximum mechanical stress location from the maximum thermal stress location.

10. The system as in claim 9, wherein each undercut feature removes a portion of the rotor body proximate to each impeller vane.

11. The system as in claim 9, further comprising a slit in one or more impeller vanes proximate to the first end.

12. The system as in claim 9, wherein the rotor body includes a bore, and each undercut feature is proximate to the bore.

13. The system as in claim 12, further comprising an arcuate surface around the bore connected to the undercut features.

14. The system as in claim 9, wherein the impeller vanes define a fluid passage across the rotor body.

15. The system as in claim 9, wherein each undercut feature extends across a dimension of each impeller vane.

16. The system as in claim 9, wherein each undercut feature comprises a compound groove.

17. A method for reducing stress in a rotor, comprising:
a. machining an undercut feature across a first end of a plurality of impeller vanes disposed on a rotor body.

18. The method as in claim 17, further comprising separating a mechanical stress location on the rotor from a thermal stress location on the rotor.

19. The method as in claim 17, further comprising machining at least a portion of the undercut feature into the rotor body proximate to the impeller vanes.

20. The method as in claim 17, further comprising machining a slit across one or more of the impeller vanes.
